(19) United States
(12) Patent Application Publication
(10) Pub. No.: US 2025/0222858 A1
(43) Pub. Date: Jul. 10, 2025

(54) SYSTEMS AND METHODS FOR SIGNALING INTENT FOR AN AUTONOMOUS VEHICLE

(71) Applicant: Torc Robotics, Inc., Blacksburg, VA (US)

(72) Inventors: Joseph R. Fox-Rabinovitz, Blacksburg, VA (US); William Davis, Blacksburg, VA (US); Akshay Pai Raikar, Blacksburg, VA (US)

(21) Appl. No.: 18/407,951

(22) Filed: Jan. 9, 2024

(51) Int. Cl. B60Q 1/50

(52) U.S. Cl. CPC B60Q 1/5037; B60Q 1/507

(57) ABSTRACT

A system for signaling intent of an autonomous truck includes at least one sensor disposed on the autonomous truck and configured to collect sensor data descriptive of a condition nearby the autonomous truck. The system includes a processing system communicatively coupled to the at least one sensor. The processing system includes a processor coupled to a memory, the memory storing executable instructions that, upon execution by the processor, configure the processor to process the sensor data to generate a message relating to the condition. The system includes a signaling display configured to display the message.

### TECHNICAL FIELD

The field of the disclosure relates generally to autonomous vehicles and, more specifically, to systems and methods for signaling intent for an autonomous truck.

### BACKGROUND OF THE INVENTION

Drivers and vehicles traveling in and through traffic, particularly at low speeds, introduces various unique challenges when compared to highway driving at highway speeds. Other vehicles are often in closer proximity, which can reduce field of view (FOV) for a given driver or vehicle. As such, that driver or vehicle may fail to perceive anomalous circumstances, such as accidents, construction in or around the roadway, or convoys, among others. The impact is greater when traveling near a tractor trailer, because it blocks more FOV, brakes more slowly, and draws more of the driver's attention as compared to a relatively smaller passenger vehicle.

Accordingly, it would be useful for tractor trailers or, more specifically, trucks (i.e., the tractor) to signal its intent, which reflects the circumstances on the road, as a courtesy to other drivers and vehicles in the vicinity.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed system for signaling intent of an autonomous truck includes at least one sensor disposed on the autonomous truck and configured to collect sensor data descriptive of a condition nearby the autonomous truck. The system includes a processing system communicatively coupled to the at least one sensor. The processing system includes a processor coupled to a memory, the memory storing executable instructions that, upon execution by the processor, configure the processor to process the sensor data to generate a message relating to the condition. The system includes a signaling display configured to display the message.

In another aspect, the disclosed processing system for signaling intent of an autonomous truck includes a memory and a processor. The memory stores executable instructions representing a signaling display module. The processor is coupled to the memory and configured to execute the signaling display module. The processor, upon execution of the display module, is configured to receive data descriptive of a condition nearby the autonomous truck, process the data to generate a message relating to the condition, and transmit the message to a signaling display for display to nearby drivers or vehicles.

In yet another aspect, the disclosed method of signaling intent of an autonomous truck includes receiving data descriptive of a condition nearby the autonomous truck, processing the data to generate a message relating to the condition, and transmitting the message to a signaling display for display to nearby drivers or vehicles.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is an illustration of an example autonomous truck;

FIG. 2 is another illustration of the autonomous truck shown in FIG. 1 with an embodiment of a signaling display deployed;

FIG. 3 is another illustration of the autonomous truck shown in FIG. 1 with another embodiment of a signaling display deployed;

FIG. 4 is a block diagram of an embodiment of an intent signaling display system;

FIG. 5A-F are illustrations of example signaling displays;

FIG. 6 is a functional block diagram of an example embodiment of an autonomous vehicle; and

FIG. 7 is a flow diagram of an example embodiment of a method of signaling intent of an autonomous truck.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Systems and methods for signaling intent to nearby drivers and vehicles are disclosed. More specifically, the disclosed systems and methods provide an intent signaling system integrated with an autonomous truck, including a signaling display that can be stowed and then deployed at desired times to signal to drivers and vehicles around the autonomous truck. The signaling display may include one or more display panels (e.g., LCD or LED displays) that can extend laterally from the autonomous truck. Alternatively, the signaling display may include one or more display panels that extend vertically above the autonomous truck sufficiently for nearby drivers and vehicles to observe. The disclosed systems may include actuators or armatures to deploy and stow the signaling display linearly (e.g., sliding up and down or left and right), rotationally (e.g., folding in and out or up and down), or a combination of both. Alternatively, for example, the signaling display may be segmented such that multiple segments fold or slide against each other, or a combination of both. In certain embodiments, signaling displays may be fixed to exterior surfaces of the autonomous truck.

The autonomous truck includes various sensors and software modules for perceiving, for example, conditions on the road ahead. Such conditions may include traffic levels, road construction, road or lane closures, line or utility work, convoys, damaged or displaced infrastructure, or weather conditions such as snow or ice, among others. The disclosed intent signaling systems inform nearby drivers and vehicles of perceived conditions and, thereby, the autonomous truck's intended response, i.e., its intent.

The autonomous truck continuously collects data from numerous sensors and processes and compiles that data into a model representing the environment, or “world,” around the autonomous truck, i.e., a “world model.” The model is an input to further processing in the autonomous trucks autonomy computing system and, in particular, for example, a behavior planning module that computes actions the autonomous truck will take. The world model and planned actions, or trajectories, from the behavior planning module are employed in the disclosed systems and methods for signaling intent. In alternative embodiments, processed sensor data may be employed independent of the world model.

Where the world model or sensor data indicate a road condition ahead, and where conditions are appropriate to deploy the signaling display, e.g., when velocity falls below an acceptable threshold, the intent signaling system derives, for example, a text message, symbols, or a combination of both to be displayed on the signaling display. The message may, in certain embodiments, be a duplication of data in the world model, or a simplified version easier for drivers or vehicles to interpret. In alternative embodiments, an image or video stream captured by a forward looking or side looking camera, for example, may be displayed on the intent signaling system to be observed by nearby drivers and vehicles. In another alternative embodiment, the intent signaling system may receive third party data relating to traffic conditions, weather, or navigation that can be relayed to other drivers and vehicles by the disclosed intent signaling systems and methods.

The disclosed systems and methods include a processing system such as an autonomy computing system or another embedded computing system, such as an electronic control unit (ECU). The processing system includes at least one or more processors and one or more memory devices. The one or more memory devices include a section of memory storing a signaling display module, which may be a hardware module, a software module, or a combination of hardware and software.

In alternative embodiments, the processing system may transmit a deploy or stow command or a message for display over one or more wired or wireless communication channels to one or more other processing systems local to the signaling display, such as an ECU or other embedded computing system. Wired communication channels may include a serial bus, a peripheral bus, CAN bus, or other suitable data link. Wireless communication channels may include Wi-Fi, NFC, Bluetooth, or other suitable data link.

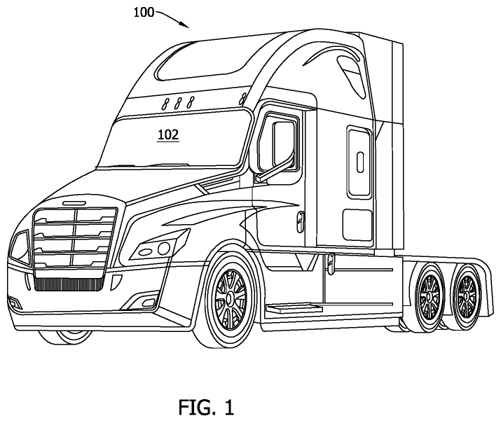

FIG. 1 is an illustration of an example autonomous truck 100 including a cab 102. Other example autonomous trucks may exclude all or parts of cab 102 when no human driver is required.

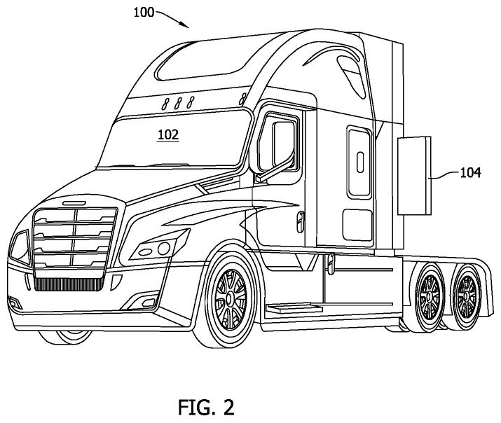

FIG. 2 is another illustration of the autonomous truck 100 having a signaling display 104 deployed laterally from a side of autonomous truck 100. Signaling display 104 is deployed and stowed by an armature that may enable one or more linear actuations or one or more rotational actuations, or a combination of linear and rotational, from the side of autonomous truck 100. For example, signaling display 104 may be mounted on an armature for one or more electric motors configured to deploy and stow signaling display 104 by “folding” signaling display 104 in and out (shown in FIG. 2).

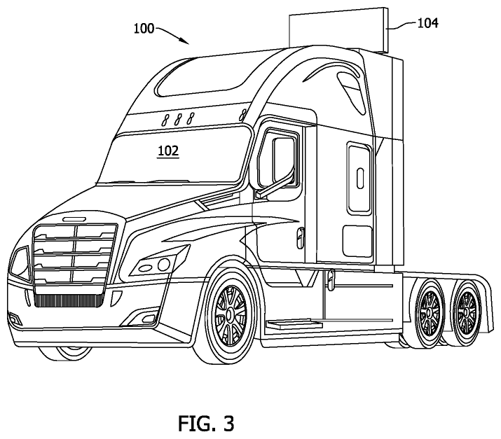

FIG. 3 is an illustration of another embodiment of signaling display 104 deployed vertically on autonomous truck 100. Signaling display 104 is deployed and stowed by an armature that may enable one or more linear actuations or one or more rotational actuations, or a combination of linear and rotational, from the top of autonomous truck 100. For example, signaling display 104 may be mounted on an armature for one or more linear actuators configured to deploy and stow signaling display 104 by “sliding” signaling display 104 up and down (shown in FIG. 3).

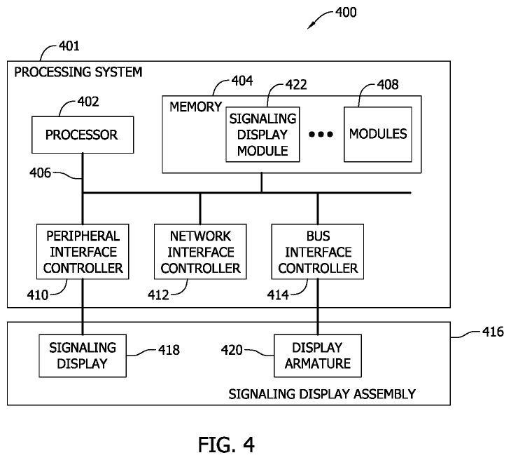

FIG. 4 is a block diagram of an embodiment of an intent signaling display system 400. Intent signaling display system includes a processing system 401 that may be embodied in an autonomy computing system, an electronic control unit (ECU), or other suitable embedded computing system. Processing system 401 includes at least one processor 402 and a memory 404. Processor 402 is coupled to memory 404 via a system bus 406. In the example embodiment, memory 404 includes one or more devices that enable information, such as executable instructions or other data, to be stored and retrieved. Memory 404 includes one or more computer readable media, such as, without limitation, dynamic random access memory (DRAM), static random access memory (SRAM), a solid state disk, or a hard disk. In the example embodiment, memory 404 stores, without limitation, application source code, application object code, configuration data, additional input events, application states, assertion statements, validation results, or any other type of data. In particular, memory 404 stores a signaling display module 422, including program code, and one or more additional software modules 408.

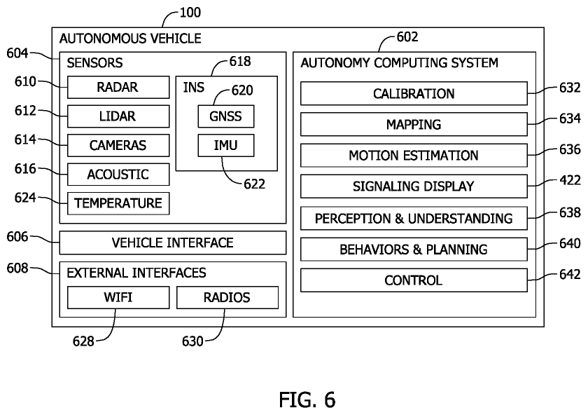

Processing system 401 further includes various interface controllers for communicating with other processing systems of autonomous truck 100, data networks, peripheral devices, sensors, controllers, ECUs, or one or more other systems or subsystems of autonomous truck 100. The interface controllers include a peripheral interface controller 410 for communicating with one or more peripheral devices, such as sensors (shown in FIG. 6). The interface controllers include a network interface controller 412 for communicating over one or more data networks, such as the Internet. The interface controllers include a bus interface controller 414 for communicating with one or more devices sitting on a bus, such as a CAN bus local to autonomous truck 100.

In the example embodiment, processor 402 is configured by accessing one or more sections of program code in memory 404 or another memory device, and executing that program code to perform one or more functions. In operation, a processor 402 executes computer-executable instructions embodied in one or more computer-executable components stored on one or more computer-readable media, such as memory 404, to implement, for example, signaling display module 422.

Signaling display module 422 controls operation of a signaling display assembly 416, including a signaling display 418 and a display armature 420. Signaling display 418 can be stowed and deployed by display armature 420 at desired times to signal to drivers and vehicles around the autonomous truck. Signaling display 418 may include one or more display panels (e.g., LED displays) that can extend laterally from the autonomous truck on display armature 420. Alternatively, signaling display 418 may include one or more display panels that extend vertically above the autonomous truck sufficient for following drivers and vehicles to observe. Display armature 420 is configured to deploy and stow signaling display 418 linearly (e.g., sliding up and down or left and right) or rotationally (e.g., folding in and out or up and down), or a combination of both.

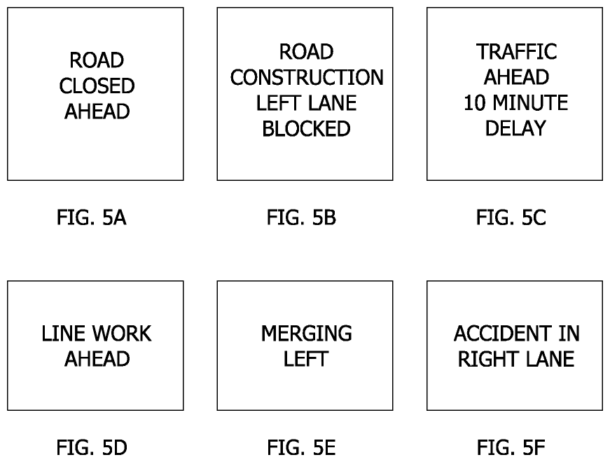

FIG. 5A-F are illustrations of example signaling displays that may be embodied in, for example, signaling display 104 shown in FIGS. 2-3 or signaling display 418 shown in FIG. 4. The signaling displays are illustrated in portrait aspect and a landscape aspect, consistent with, for example, a side mounting on the autonomous truck and a vertical mounting on the autonomous truck, respectively. More specifically, FIG. 5A illustrates a signaling display indicating “ROAD CLOSED AHEAD,” which signals to drivers and vehicles around the autonomous truck that a road closure is perceived by the autonomous truck and may not be observable by the other drivers and vehicles. Moreover, the signal implies the autonomous truck may modify its trajectory in response to the road closure, although which lane or lanes of the road are closed is either unknown or at least not signaled.

FIG. 5B illustrates a signaling display indicating “ROAD CONSTRUCTION LEFT LANE BLOCKED,” which signals to drivers and vehicles around the autonomous truck that the left lane ahead is blocked due to ongoing road construction. The signal implies caution and that the autonomous truck may modify its trajectory in response to the lane closure. For example, if the autonomous truck is operating in the left lane, the signal implies the autonomous truck is planning to merge from that lane and to proceed cautiously through an area of road construction. If the autonomous truck is operating in another lane, the signal implies the autonomous truck may reduce speed as a courtesy to other drivers and vehicles that may need to merge, and to proceed cautiously through an area of road construction.

FIG. 5C illustrates a signaling display indicating “TRAFFIC AHEAD 10 MINUTE DELAY,” which signals to drivers and vehicles around the autonomous truck that the autonomous truck perceives traffic congestion ahead and anticipates a slowdown. The signal also indicates an estimate of the delay, which may be derived, for example, heuristically based on recently observed traffic flow in the area or based on a detected speed of the traffic.

FIG. 5D illustrates a signaling display indicating “LINE WORK AHEAD”, which signals to drivers and vehicles around the autonomous truck that the autonomous truck perceives line or other utility workers overhead in the area ahead. The signal implies the autonomous truck intends to reduce speed or potentially change lanes to avoid the line work.

FIG. 5E illustrates a signaling display indicating “MERGING LEFT”, which signals to drivers and vehicles around the autonomous truck that the autonomous truck intends to merge left on the road ahead.

FIG. 5F illustrates a signaling display indicating “ACCIDENT IN RIGHT LANE”, which signals to drivers and vehicles around the autonomous truck that the autonomous truck perceives an accident on the roadway ahead, specifically in the right lane. The signal implies the autonomous truck intends to reduce speed, merge, or a combination of both.

Embodiments shown in FIGS. 5A-5F generally describe conditions observed by the autonomous truck. Alternatively, the messages displayed, in certain embodiments, are prescriptive and help inform, suggest, or potentially instruct nearby drivers and vehicles to take an action.

FIG. 6 is a functional block diagram of an example embodiment of autonomous vehicle 100. In the example embodiment, autonomous vehicle 100 includes an autonomy computing system 602, sensors 604, a vehicle interface 606, and external interfaces 608.

In the example embodiment, sensors 604 include various sensors such as, for example, radio detection and ranging (RADAR) sensors 610, light detection and ranging (LiDAR) sensors 612, cameras 614, acoustic sensors 616, temperature sensors 624, inertial navigation system (INS) 618, which includes one or more global navigation satellite system (GNSS) receivers 620 and at least one inertial measurement unit (IMU) 622. Other sensors 604 not shown in FIG. 6 may include, for example, acoustic (e.g., ultrasound), internal vehicle sensors, meteorological sensors, or other types of sensors. Sensors 604 generate respective output signals based on detected physical conditions of autonomous vehicle 100 and its proximity. As described in further detail below, these signals may be used by autonomy computing system 602 to determine how to control operation of autonomous vehicle 100.

Cameras 614 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 614 and the images from each of the multiple cameras 614 may be stitched or combined to generate a visual representation of the multiple cameras' fields of view, which may be used to, for example, generate a bird's eye view of the environment surrounding autonomous vehicle 100. In some embodiments, the image data generated by cameras 614 may be sent to autonomy computing system 602 or other aspects of autonomous vehicle 100 and this image data may include autonomous vehicle 100 or a generated representation of autonomous vehicle 100. In some embodiments, one or more systems or components of autonomy computing system 602 may overlay labels to the features depicted in the image data, such as on a raster layer or other semantic layer of a high-definition (HD) map.

LiDAR sensors 612 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 610 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments the inputs from cameras 614, RADAR sensors 610, or LiDAR sensors 612 may be fused or used in combination to determine conditions (e.g., locations of other objects) around autonomous vehicle 100.

GNSS receiver 620 is positioned on autonomous vehicle 100 and may be configured to determine a location of autonomous vehicle 100, which it may embody as GNSS data, as described herein. GNSS receiver 620 may be configured to receive one or more signals from a global navigation satellite system (e.g., GPS constellation) to localize autonomous vehicle 100 via geolocation. In some embodiments, GNSS receiver 620 may provide an input to or be configured to interact with, update, or otherwise utilize one or more digital maps, such as an HD map (e.g., in a raster layer or other semantic map). In some embodiments, GNSS receiver 620 may provide direct velocity measurement via inspection of the Doppler effect on the signal carrier wave. Multiple GNSS receivers 620 may also provide direct measurements of the orientation of autonomous vehicle 100. For example, with two GNSS receivers 620, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 622 is a micro-electrical-mechanical (MEMS) device that measures and reports one or more features relating to the motion of autonomous vehicle 100, although other implementations are contemplated, such as mechanical, fiber-optic gyro (FOG), or FOG-on-chip (SiFOG) devices. IMU 622 may measure an acceleration, angular rate, and or an orientation of autonomous vehicle 100 or one or more of its individual components using a combination of accelerometers, gyroscopes, or magnetometers. IMU 622 may detect linear acceleration using one or more accelerometers and rotational rate using one or more gyroscopes and attitude information from one or more magnetometers. In some embodiments, IMU 622 may be communicatively coupled to one or more other systems, for example, GNSS receiver 620 and may provide input to and receive output from GNSS receiver 620 such that autonomy computing system 602 is able to determine the motive characteristics (acceleration, speed/direction, orientation/attitude, etc.) of autonomous vehicle 100.

In the example embodiment, vehicle interface 606 is configured, for example, to send commands to various aspects of autonomous vehicle 100 that control the motion of autonomous vehicle 100 (e.g., engine, throttle, steering, brakes, etc.) and to receive input data from one or more sensors 610 (e.g., internal sensors). External interfaces 206 are configured to enable autonomous vehicle 100 to communicate with an external network via, for example, a wired or wireless connection, such as Wi-Fi 628 or other radios 630. In embodiments including a wireless connection, the connection may be a wireless communication signal (e.g., Wi-Fi, cellular, LTE, 5g, Bluetooth, etc.).

In some embodiments, external interfaces 608 may be configured to communicate with an external network via a wired connection, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 608 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 602 is implemented by one or more processors and memory devices of autonomous vehicle 100. Autonomy computing system 602 includes modules, which may be hardware components (e.g., processors or other circuits) or software components (e.g., computer applications or processes executable by autonomy computing system 602), or a combination of hardware and software, configured to generate outputs, such as control signals, based on inputs received from, for example, sensors 604. These modules may include, for example, a calibration module 632, a mapping module 634, a motion estimation module 636, a perception and understanding module 638, a behaviors and planning module 640, and a control module 642.

Perception and understanding module 638 detects conditions on the road ahead. Such conditions may include traffic levels, road construction, road or lane closures, line or utility work, or convoys, among others. Autonomous vehicle 100 continuously collects data from sensors 604 and perception and understanding module 638 processes and compiles that data into a model representing the environment, or “world,” around autonomous vehicle 100, i.e., a “world model.” The model is an input to further processing in autonomy computing system 602 and, in particular, for example, behavior planning module 640. The world model and planned actions, or trajectories, from behavior planning module 640 are employed in signaling display module 422. In alternative embodiments, processed sensor data from sensors 604 may be employed by signaling display module 422 independent of the world model.

Signaling display module 422 is configured to receive data indicating a road condition ahead, and where conditions are appropriate to deploy the signaling display, such as signaling display 418 shown in FIG. 4, the signaling display module 422 derives, for example, a text message, symbols, or a combination of both to be displayed on signaling display 418. The message may, in certain embodiments, be a duplication of data in the world model, or a simplified version easier for drivers or vehicles to interpret. In certain embodiments, signaling display module 422 may only receive commands to deploy signaling display 418, display a message, and stow signaling display 418. In alternative embodiments, an image or video stream captured by a forward looking or side looking camera (of cameras 614), for example, may be displayed on signaling display 418 to be observed by nearby drivers and vehicles. In another alternative embodiment, signaling display module 422 may receive third party data via external interfaces 608 relating to traffic conditions, weather, or navigation that can be relayed to other drivers and vehicles by the disclosed intent signaling systems and methods.

Signaling display module 422 is configured to determine whether autonomous vehicle 100 is traveling at a low enough speed to deploy signaling display 418, and whether any lateral or vertical obstructions are present that may impede armature 420 from safely deploying signaling displaying 418. In certain embodiments, perception and understanding module 638, in combination with sensors 604 detects whether velocity is below a set threshold to deploy signaling display 418, and detects whether lateral or vertical obstructions exist. Likewise, signaling display module 422, in certain embodiments, may be embodied as a component of behaviors and planning module 640.

Referring again to FIG. 4, signaling display module 422 may control display armature 420 for example, through bus interface controller 414. Signaling display module 422 may control signaling display 418 through peripheral interface controller 410. In alternative embodiments, processing system 401, which may be embodied as autonomy computing system 602, may transmit a deploy or stow command or a message for display over one or more wired or wireless communication channels to one or more other processing systems local to signaling display assembly 416, such as an ECU or other embedded computing system. Wired communication channels may include a serial bus, a peripheral bus, CAN bus, or other suitable data link. Wireless communication channels may include Wi-Fi, NFC, Bluetooth, or other suitable data link.

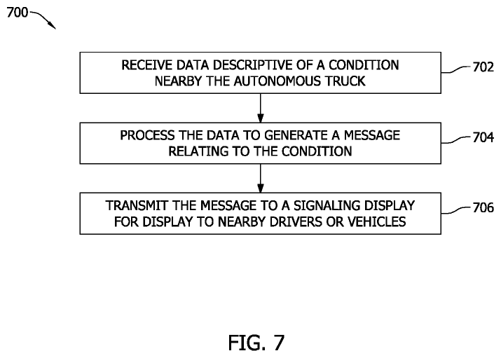

FIG. 7 is a flow diagram of an example embodiment of a method 700 of signaling intent of an autonomous truck, such as autonomous truck 100 shown in FIGS. 2-3 and 6. More specifically, method 700 may be embodied, for example, in a processing system onboard autonomous truck 100, such as autonomy computing system 602 or intent signaling system 400 (shown in FIG. 4). Referring to the embodiment shown in FIG. 4, intent signaling system 400 receives 702 data descriptive of a condition nearby autonomous truck 100. The condition may include, for example, a road closure, construction, line work, a lane closure, traffic congestion, etc. The data may be received 702 from a remote data source, such as a navigation system, municipal broadcasting system, or a weather service. Alternatively, the data may be received 702 from one or more sensors onboard autonomous truck 100, such as sensors 604 shown in FIG. 6. In another alternative embodiment, the data may be received 702 from autonomy computing system 602, for example, in the form of a world model describing the environment in which autonomous truck 100 is operating.

In certain embodiments, intent signaling system 400 determines deployment conditions are satisfied to deploy signaling display 418. The deployment conditions may include autonomous truck 100 traveling below a threshold speed, e.g., below 30 miles per hour (MPH), below 40 MPH, below 55 MPH, etc. The deployment conditions may also include being clear of any obstructions that may impede display armature 420. For example, in an embodiment where signaling display 418 extends above autonomous truck 100, there must not be any overhead obstructions such as an overpass, signage, overhead lines, etc. In embodiments where signaling display 418 extends laterally from a side of autonomous truck 100, there must not be any lateral obstructions, such as structures or other vehicles. If deployment conditions are met, then intent signaling system initiates actuation of display armature 420 to deploy signaling display 418.

Intent signaling system 400 and, more specifically, processing system 401, processes 704 the data to generate a message relating to the condition. Processing 704 the data may include, for example, translating or copying the data directly into the message. Alternatively, processing system 401 may use the data to index into an array of messages, or a table of messages, or another data structure such as a priority queue or map, to generate at least one element of the message to be displayed. For example, the data received from autonomy computing system 602, e.g., the world model or planning module, may be more comprehensive than the message needs to be. Accordingly, processing system 401 indexes into a map based on one or more elements of the data to generate a simpler message that can be displayed for the benefit of other drivers and vehicles around autonomous truck 100.

Once the message is generated, intent signaling system 400 transmits 706 the message to signaling display 418 for display to nearby drivers or vehicles.

An example technical effect of the methods, systems, and apparatus described herein includes at least one of: (a) displaying nearby road or other conditions to nearby drivers and vehicles; (b) signaling intent of the autonomous truck in response to perceived nearby conditions; and (c) improving awareness of nearby conditions and planned cations of the autonomous truck for nearby drivers or vehicles.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for signaling intent of an autonomous truck, the system comprising:
at least one sensor disposed on the autonomous truck and configured to collect sensor data descriptive of a condition nearby the autonomous truck;
a processing system communicatively coupled to the at least one sensor, the processing system comprising a processor coupled to a memory, the memory storing executable instructions that, upon execution by the processor, configure the processor to:
process the sensor data to generate a message relating to the condition; and
a signaling display configured to display the message.

2. The system of claim 1 further comprising an armature configured to be coupled to the autonomous truck and on which the signaling display is mounted.

3. The system of claim 2, wherein the processing system is further configured to:
determine deployment conditions are satisfied to deploy the signaling display; and
initiate actuation of the armature to deploy the signaling display.

4. The system of claim 3, wherein actuation of the armature includes rotational actuation of the armature.

5. The system of claim 3, wherein actuation of the armature includes linear actuation of the armature.

6. The system of claim 3, wherein the deployment conditions include a speed of the autonomous truck being below a threshold speed.

7. The system of claim 1, wherein processing the sensor data comprises employing the sensor data to index into a map of messages to generate at least one element of the message. to be displayed.

8. A processing system for signaling intent of an autonomous truck, the processing system comprising:
a memory storing executable instructions representing a signaling display module;
a processor coupled to the memory and configured to execute the signaling display module, the processor, upon execution of the display module, configured to:
receive data descriptive of a condition nearby the autonomous truck;
process the data to generate a message relating to the condition; and
transmit the message to a signaling display for display to nearby drivers or vehicles.

9. The processing system of claim 8, wherein the processor is further configured to receive the data from a remote data source via a wireless connection.

10. The processing system of claim 8, wherein the processor is further configured to receive the data from a sensor onboard the autonomous truck.

11. The processing system of claim 8, wherein the processor is further configured to receive the data from an autonomy computing system.

12. The processing system of claim 8, wherein the memory is further configured to store a map of messages, and wherein processing the data comprises employing the data to index into the map of messages to generate at least one element of the message. to be displayed.

13. The processing system of claim 8 further comprising a peripheral interface controller, and wherein transmitting the message comprises transmitting a display signal via the peripheral interface to the signaling display.

14. The processing system of claim 8 further comprising a bus interface controller, and wherein the processor is further configured to:
determine deployment conditions are satisfied to deploy the signaling display; and
initiate actuation of an armature to deploy the signaling display.

15. A method of signaling intent of an autonomous truck, the method comprising:
receiving data descriptive of a condition nearby the autonomous truck;
processing the data to generate a message relating to the condition; and
transmitting the message to a signaling display for display to nearby drivers or vehicles.

16. The method of claim 15, wherein receiving the data comprises receiving the data from a remote data source via a wireless connection.

17. The method of claim 15, wherein receiving the data further comprises receiving the data from a sensor onboard the autonomous truck.

18. The method of claim 15, wherein receiving the data further comprises receiving the data from an autonomy computing system.

19. The method of claim 15, wherein processing the data comprises employing the data to index into a map of messages to generate at least one element of the message. to be displayed.

20. The method of claim 15 further comprising:
determining deployment conditions are satisfied to deploy the signaling display; and
initiating actuation of an armature to deploy the signaling display.
